(19) United States
(12) Patent Application Publication
(10) Pub. No.: US 2014/0055002 A1
(43) Pub. Date: Feb. 27, 2014

(54) VIBRATION POWER GENERATOR, ROTATING BODY AND COMMUNICATION DEVICE

(71) Applicant: PANASONIC CORPORATION, Osaka (JP)

(72) Inventors: Hiroshi Nakatsuka, Osaka (JP); Keiji Onishi, Osaka (JP); Takehiko Yamakawa, Osaka (JP)

(73) Assignee: PANASONIC CORPORATION, Osaka (JP)

(21) Appl. No.: 13/881,528

(22) PCT Filed: Oct. 5, 2012
(86) PCT No.: PCT/JP2012/006445

§ 371 Date: Apr. 25, 2013

(30) Foreign Application Priority Data
Oct. 19, 2011 (JP) 2011-229462

(51) Int. Cl. H02N 1/08

(52) U.S. Cl. CPC H02N 1/08
USPC 310/308; 310/300

(57) ABSTRACT

A vibration power generator 110 including a first fixed substrate 111L, a second fixed substrate 111U, a movable substrate 112 which is vibratory relative to the first and second fixed substrates, a plurality of first electrodes 119a formed over the second fixed substrate, a plurality of second electrodes 119b formed on the movable substrate and opposed to the first electrodes, wherein one of the first electrode 119a and the second electrode 119b includes a film holding a charge, is fixed to a rotating body such that the first fixed substrate 111L, the second fixed substrate 111U and the movable substrate 112 are perpendicular to a radial direction of the rotating body and the first fixed substrate is disposed nearer to a rotational axis side of the rotating body.

### TECHNICAL FIELD

The present invention relates to a vibration power generator which is suitable for being installed fixedly in a rotating body, the rotating body using the same and a communication device using the same.

### BACKGROUND ART

A power generation apparatus installed in a rotating body has been known (see, for example, Patent Document 1)

FIG. 12 is a view showing an arrangement example described in Patent Document 1 (see FIG. 4 and paragraphs 0021 to 0022) of the power generation apparatus in the rotating body, which is an example of the power generation apparatus where the power generation apparatus is disposed fixedly in a wheel (the rotating body). In Patent Document 1, there is disclosed a power generation apparatus wherein a power generator installed in the rotating body has a fixed portion provided with a moving path of approximately-arc shape and a movable portion which is disposed such that it is movable along the moving path and is configured such that power is generated by the movement thereof relative to the fixed portion, wherein the curvature radius of the moving path is smaller than the curvature radius of the rotating body.

FIG. 13 is a cross-sectional view of the power generation apparatus 50 described in Patent Document 1 (see FIG. 2 and paragraphs 0012 to 0020).

The power generation apparatus 50 has a fixed portion 1 as a housing with internal space, which is formed such that opposing upper and lower sides of the internal space are formed into the approximately-arc shape, and a movable portion 2 which is movable relative to the fixed portion 1. A first power generation part 10 and a second power generation part 20 are constructed in the inside of the fixed portion 1.

In the fixed portion 1, fixed substrates 1a of approximately-arc shape are provided along the upper side and the lower side of the internal space, respectively. On each fixed substrate 1a, collector electrodes 3 consisting of a collector portion 3a and a connection portion 3b, and collector electrodes 4 consisting of a collector portion 4a and a connection portion 4b are formed. The collector electrodes 3 and the collector electrodes 4 are disposed such that the collector portion 3a and the collector portion 4a are adjacent to each other with a predetermined interval. The connection portions 3b and 4b connect the collector electrodes 3a and collector electrodes 4a, respectively. Further, the connection portions 3b for the collector electrodes 3a and the connection portions 4b for the collector electrodes 4a are connected via loads 5, respectively.

The movable portion 2 has a weight 2a of which upper side and lower side are formed into approximately-arc shape such that they are along with the arc shape of the fixed portion 1. The weight 2a is provided with movable substrates 2b which are formed along the arc shape and movable together with the weight 2a, on the surfaces of the upper and lower sides, respectively. A silicon oxide film 2c is formed on a surface of each movable substrate 2b.

On the surface of the silicon oxide film 2c, guard electrodes 2d are formed with a predetermined interval. Electret 2e which is formed by injecting a charge is formed in a region of the silicon oxide film 2c between the guard electrodes 2d. The electret 2e has function of holding a predetermined charge semipermanently. Further, the guard electrode 2d is grounded.

When the movable portion 2 is reciprocated relative to the fixed portion 1 in the A direction by the rotation of the wheel (the rotating body), approximately-arc movement of the respective electrets 2e relative to the respective collector electrodes 3 and 4 are made, while they are kept to be opposed to the electrodes 3 and 4. This movement generates increase and decrease of an overlapped area which is formed by the electret-material region and the conductive surface region opposed to the electret-material region, resulting in change of charges in the conductive surface region. The power generation apparatus (a power generation apparatus) of electrostatic induction type generates power by taking out the change in an amount of charge as the electric energy.

### PRIOR ART DOCUMENTS

### Patent Document

Patent Document 1: JP 2010-41813 A

### SUMMARY OF INVENTION

### Problems to be Solved by the Invention

In one aspect, the present invention provides a vibration power generator wherein power output does not depend largely on a rotation speed of the rotating body and is stabilized during both a low-speed rotation and a high-speed rotation. In another aspect, the present invention, provides a rotating body having a power generation apparatus provided with the vibration power generator. In a further aspect, the present invention provides a communication device which is configured such that power generated in the rotating body is supplied thereto.

### Means for Solving the Problems

One embodiment of the present invention is a vibration power generator including:

a first fixed substrate;

a second fixed substrate which is disposed to be opposed to the first fixed substrate;

a movable substrate which is disposed between the first fixed substrate and the second fixed substrate to be opposed to the first fixed substrate and the second fixed substrate, and is vibratory with respect to the first fixed substrate and the second fixed substrate;

a plurality of first electrodes formed over a surface of the second fixed substrate which surface is opposed to the movable substrate;

a plurality of second electrodes formed over a surface of the movable substrate which surface is opposed to the second fixed substrate;

wherein one of the first electrode and the second electrode includes a film holding a charge, and

a first gap is smaller than a second gap assuming that the first gap is a distance between the first fixed substrate and the movable substrate and the second gap is a distance between the second fixed substrate and the movable substrate.

### Effect of the Invention

The rotating body according to one embodiment of the present invention makes it possible to reduce the effect of the rotational speed of the rotating body on the power output and to give the power output stably.

### BRIEF DESCRIPTION OF DRAWINGS

In FIG. 1, (a) is a view illustrating a rotating body of a first embodiment and (b) is a view illustrating arrangement of the rotating body and a power generation apparatus;

FIG. 2a is a graph showing frequency spectrum of acceleration of tangential vibration of a tire installed in a passenger car when the tire is rotated at a low speed;

FIG. 2b is a graph showing frequency spectrum of acceleration of tangential vibration of a tire installed in a passenger car when the tire is rotated at a high speed;

FIG. 2c is a graph showing frequency spectrum of acceleration of axial vibration of a tire installed in a passenger car when the tire is rotated at a low speed;

FIG. 2d is a graph showing frequency spectrum of acceleration of axial vibration of a tire installed in a passenger car when the tire is rotated at a high speed;

In FIG. 3, (a) is a cross-sectional view of a vibration power generator of the first embodiment, and (b) is a cross-sectional view showing the vibration power generator of (a) when centrifugal force is applied thereto;

FIG. 4 is a spectional perspective view illustrating spring structure of the vibration power generator of the first embodiment;

FIG. 5 is a cross-sectional view of a vibration power generator according to a second embodiment;

In FIG. 6, (a) is a cross-sectional view of a vibration power generator according to a third embodiment, and (b) is a cross-sectional view of the vibration power generator of (a) when a substrate 312 is displaced by external force;

FIG. 7a is a schematic view showing a vibration power generation apparatus of a fourth embodiment;

FIG. 7b is a schematic view showing a vibration power generation apparatus according to a modified example of the fourth embodiment;

FIG. 7c is a schematic view showing a vibration power generation apparatus according to another modified example of the fourth embodiment;

FIG. 8 is a block diagram showing a vibration power generation apparatus according to a fifth embodiment;

FIG. 9 is a block diagram showing a vibration power generation apparatus according to a sixth embodiment;

FIG. 10 is a block diagram showing a communication device according to a seventh embodiment, using a vibration power generation apparatus;

FIG. 11 is a block diagram sowing an electronic device according to an eighth embodiment, using a vibration power generation apparatus;

FIG. 12 is a view showing a conventional vibration power generation apparatus fixed to a rotating body;

FIG. 13 is a cross-sectional view of the vibration power generation apparatus shown in FIG. 12.

### DESCRIPTION OF EMBODIMENTS

### Basis for Finding One Embodiment of the Invention

According to the study of the inventors, a conventional power generation apparatus disclosed in Patent Document 1 has a problem that a power generation amount is small when the rotating body is rotated at a low speed since the power generation amount depends on the rotation acceleration, and a problem the power generation amount is limited by the increase in sliding resistance due to the change in centrifugal force. Then, the inventors studied intensively and found that the output can be given stably irrespective of the rotation speed by constructing the rotating body such that the power generation of the vibration power generator is made by axial-direction vibration which shows small change to the change of the rotation speed. Further, such a rotating body can be designed such that a frequency range which can be employed is wide. As a result, the inventors obtained the following aspects of the present invention based on this finding.

### (First Aspect)

A first aspect is a vibration power generator including:

a first fixed substrate;

a second fixed substrate which is disposed to be opposed to the first fixed substrate;

a movable substrate which is disposed between the first fixed substrate and the second fixed substrate to be opposed to the first fixed substrate and the second fixed substrate, and is vibratory with respect to the first fixed substrate and the second fixed substrate;

a plurality of first electrodes formed over a surface of the second fixed substrate which surface is opposed to the movable substrate;

a plurality of second electrodes formed over a surface of the movable substrate which surface is opposed to the second fixed substrate;

wherein one of the first electrode and the second electrode includes a film holding a charge, and

a first gap is smaller than a second gap assuming that the first gap is a distance between the first fixed substrate and the movable substrate and the second gap is a distance between the second fixed substrate and the movable substrate. The first aspect is the vibration power generator which is suitable for being installed in the rotating body, and can generate power by the axial-direction vibration showing small change to the change of the rotation speed. Since the movable substrate does not contact with the other members in the first aspect, there is no problem of change in sliding resistance caused by the centrifugal force during the rotation.

### (Second Aspect)

A second aspect is the vibration power generator according to the first embodiment which further includes:

a plurality of third electrodes formed over a surface of the first fixed substrate which surface is opposed to the movable substrate; and

a plurality of fourth electrodes formed over a surface of the movable substrate which surface is opposed to the first fixed substrate;

wherein one of the third electrode and the fourth electrode includes a film holding a charge. The vibration power generator according to the second aspect can suppresses the change in power output due to the centrifugal force to stabilize the output further.

### (Third Aspect)

A third aspect is the vibration power generator according to the second aspect, wherein:

a direction in which the first electrodes, the second electrodes, the third electrodes and the fourth electrodes are lined up is parallel to a vibrational direction of the movable substrate;

the first electrodes are disposed such that they are parallel to each other and distances D1 are the same wherein each distance D1 is a distance between centers of two adjacent first electrodes;

the second electrodes are disposed such that they are parallel to each other and distances D2 are the same wherein each distance D2 is a distance between centers of two adjacent second electrodes;

the third electrodes are disposed such that they are parallel to each other and distances D3 are the same wherein each distance D3 is a distance between centers of two adjacent third electrodes;

the fourth electrodes are disposed such that they are parallel to each other and distances D4 are the same wherein each distance D4 is a distance between centers of two adjacent fourth electrodes; and

D1, D2, D3 and D4 satisfy a relation of D1=D2>D3=D4. The vibration power generator of the third aspect makes it possible to obtain more stabilized power therefrom irrespective of the speed of the rotating body.

### (Fourth Aspect)

A fourth aspect is the vibration power generator according to the second aspect, wherein:

the first electrodes, the second electrodes, the third electrodes and the fourth electrodes have a rectangular shape when viewed in a direction perpendicular to the surface of the first substrate;

a direction in which the first electrodes, the second electrodes, the third electrodes and the fourth electrodes are lined up is parallel to a vibrational direction of the movable substrate; and

W1, W2, W3 and W4 satisfy a relation of W1=W2>W3=W4 wherein W1, W2, W3 and W4 are a width of the first electrode, a width of the second electrode, a width of the third electrode, and a width of the fourth electrode in the vibrational direction of the movable direction, respectively. The vibration power generator of the fourth aspect makes it possible to obtain more stabilized power therefrom irrespective of the speed of the rotating body.

### (Fifth Aspect)

A fifth aspect is the vibration power generator according to the first aspect, which further includes:

a fixing structure which connects the first fixed substrate and the second fixed substrate; and

a spring connected to the fixing structure and the movable substrate;

wherein the movable substrate is maintained in the air by the spring, and

a size of the spring in a vibrational direction of the movable substrate is smaller than a size of the spring in a thickness direction of the movable substrate. When the vibration in a direction of the rotational axis of the rotating body is exerted in the vibration power generator of the fifth aspect, the movable substrate can be vibrated even at a low acceleration, and the displacement of the movable substrate can be made small even if a large acceleration is applied in the centrifugal direction. As a result, the vibration power generator of the fifth aspect can be stably operated by the vibration during the rotation irrespective of the rotational speed of the rotating body.

### (Sixth Aspect)

A sixth aspect is a vibration power generation apparatus including:

a vibration power generator according to any one of the first to fifth aspects; and

a circuit which converts an AC output voltage from the vibration power generator and outputs a DC voltage.

### (Seventh Aspect)

A seventh aspect is the vibration power generation apparatus according to the sixth aspect, which further includes a battery.

### (Eighth Aspect)

An eighth aspect is a rotating body including a vibration power generation apparatus wherein:

the vibration power generation apparatus includes a vibration power generator and a circuit which converts an AC output voltage from the vibration power generator and outputs a DC voltage;

the vibration power generator includes:

a first fixed substrate;

a second fixed substrate which is disposed to be opposed to the first fixed substrate;

a movable substrate which is disposed between the first fixed substrate and the second fixed substrate to be opposed to the first fixed substrate and the second fixed substrate, and is vibratory with respect to the first fixed substrate and the second fixed substrate;

a plurality of first electrodes formed over a surface of the second fixed substrate which surface is opposed to the movable substrate;

a plurality of second electrodes formed over a surface of the movable substrate which surface is opposed to the second fixed substrate;

wherein one of the first electrode and the second electrode includes a film holding a charge, and a first gap is smaller than a second gap assuming that the first gap is a distance between the first fixed substrate and the movable substrate and the second gap is a distance between the second fixed substrate and the movable substrate;

wherein the first fixed substrate, the second fixed substrate and the movable substrate are disposed perpendicular to a radial direction of the rotating body, and

the vibration power generator is fixed to the rotating body such that the first fixed substrate is disposed on the rotational axial side of the rotating body. The rotating body of the eighth aspect is a rotating body wherein the vibration power generator of the first aspect is fixed thereto such that the first fixed substrate is disposed in a predetermined manner.

### (Ninth Aspect)

A ninth aspect is the rotating body of the eighth aspect wherein the vibration power generator further includes:

a plurality of third electrodes formed over a surface of the first fixed substrate which surface is opposed to the movable substrate; and

a plurality of fourth electrodes formed over a surface of the movable substrate which surface is opposed to the first fixed substrate;

wherein one of the third electrode and the fourth electrode includes a film holding a charge. The vibration power generator in the rotating body of the ninth aspect is the vibration power generator of the second aspect.

### (Tenth Aspect)

A tenth aspect is the rotating body of the ninth aspect wherein, in the vibration power generator,

a direction in which the first electrodes, the second electrodes, the third electrodes and the fourth electrodes are lined up is parallel to a vibrational direction of the movable substrate;

the first electrodes are disposed such that they are parallel to each other and distances D1 are the same wherein each distance D1 is a distance between centers of two adjacent first electrodes;

the second electrodes are disposed such that they are parallel to each other and distances D2 are the same wherein each distance D2 is a distance between centers of two adjacent second electrodes;

the third electrodes are disposed such that they are parallel to each other and distances D3 are the same wherein each distance D3 is a distance between centers of two adjacent third electrodes;

the fourth electrodes are disposed such that they are parallel to each other and distances D4 are the same wherein each distance D4 is a distance between centers of two adjacent fourth electrodes; and

D1, D2, D3 and D4 satisfy a relation of D1=D2>D3=D4. The vibration power generator in the rotating body of the tenth aspect is the vibration power generator of the third aspect.

### (Eleventh Aspect)

An eleventh aspect is the rotating body according to the tenth aspect wherein, in the vibration power generator,

the first electrodes, the second electrodes, the third electrodes and the fourth electrodes have a rectangular shape when viewed in a direction perpendicular to the surface of the first substrate;

a direction in which the first electrodes, the second electrodes, the third electrodes and the fourth electrodes are lined up is parallel to a vibrational direction of the movable substrate; and

W1, W2, W3 and W4 satisfy a relation of W1=W2>W3=W4 wherein W1, W2, W3 and W4 are a width of the first electrode, a width of the second electrode, a width of the third electrode, and a width of the fourth electrode in the vibrational direction of the movable direction, respectively. The vibration power generator in the rotating body of the eleventh aspect is the vibration power generator of the fourth aspect.

### (Twelfth Aspect)

A twelfth aspect is the rotating body according to the eighth aspect, wherein the vibration power generator further includes:

a fixing structure which connects the first fixed substrate and the second fixed substrate; and

a spring connected to the fixing structure and the movable substrate;

wherein the movable substrate is maintained in the air by the spring, and

a size of the spring in a vibrational direction of the movable substrate is smaller than a size of the spring in a radial direction of the movable substrate. The vibration power generator in the rotating body of the twelfth aspect is the vibration power generator of the fifth aspect.

### (Thirteenth Aspect)

A thirteenth aspect is the rotating body according to any one of the ninth aspect to the eleventh aspect, wherein the vibration power generation apparatus includes at least:

a first rectifying circuit which is connected to the first electrodes and the second electrodes of the vibration power generator; and

a second rectifying circuit which is connected to the third electrodes and the fourth electrodes of the vibration power generator;

wherein a voltage of one of the first rectifying circuit and the second rectifying circuit is supplied to a load.

### (Fourteenth Aspect)

A fourteenth aspect is the rotating body according to the eighth aspect, wherein the vibration power generation apparatus includes:

a voltage conversion circuit for converting a DC voltage output from the rectifying circuit into a voltage at a predetermined voltage level;

a storage circuit for storing power generated by the vibration power generator when an output from the vibration power generation apparatus is unnecessary;

a voltage control circuit for controlling an output voltage from the voltage conversion circuit or the storage circuit to a predetermined voltage; and

an output switching circuit for switching the output from the voltage conversion circuit to the storage circuit or the voltage control circuit.

### (Fifteenth Aspect)

A fifteenth aspect is a rotating body for a vehicle which is the rotating body according to any one of the eighth to fourteenth aspects.

### (Sixteenth Aspect)

A sixteenth aspect is a communication device including the vibration power generation apparatus according to the sixth aspect or the seventh aspect.

### (Seventeenth Aspect)

A seventeenth aspect is an electronic device which includes the vibration power generation apparatus according to the sixth aspect or the seventh aspect.

Embodiments of the present invention will be described in detail below with reference to the accompanying drawings. In the following description, terms indicative of specific directions and positions (for example, the terms “upper”, “lower”, “left”, “right”, and other terms including these words) are used if necessary. These words are used only for easy understanding of the invention referring to the drawings, and are construed to have no meanings to limit the technical scope of the invention. The same or equivalent parts or members in the drawings are indicated by the same reference numerals in the drawings.

### 1. First Embodiment

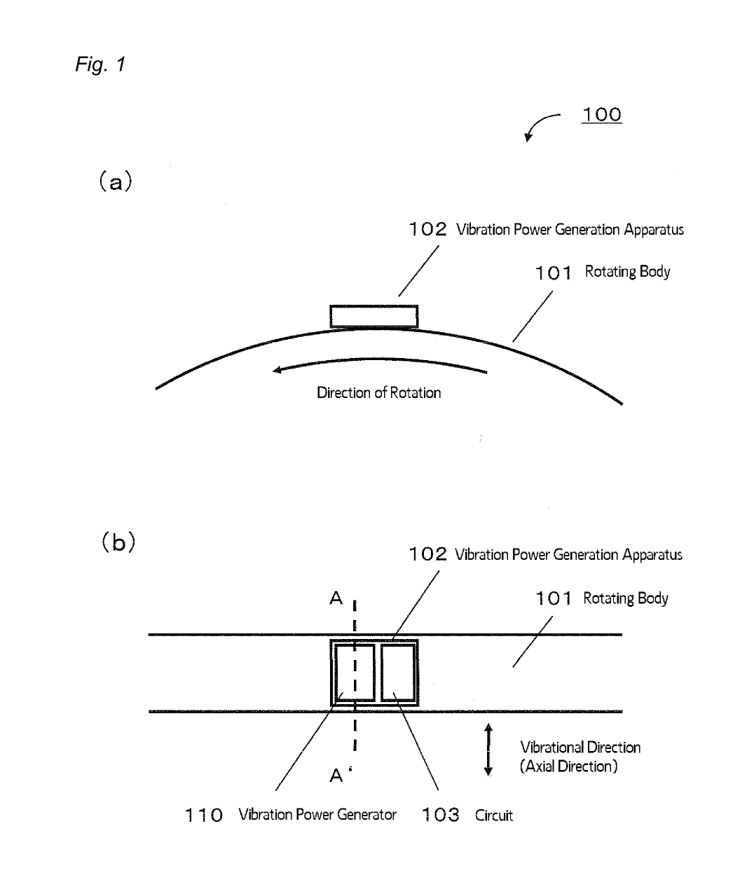

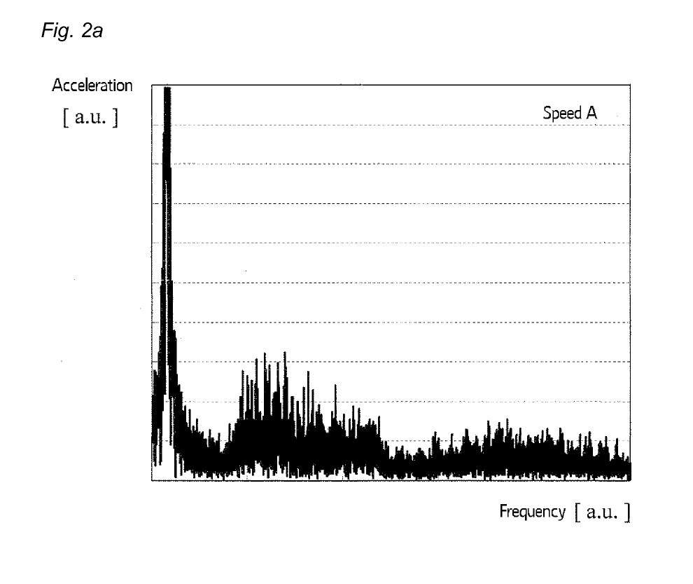

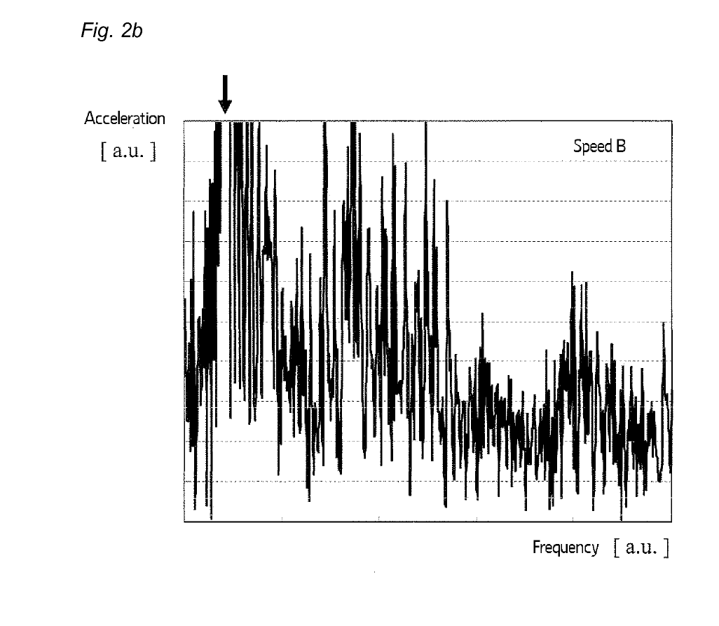

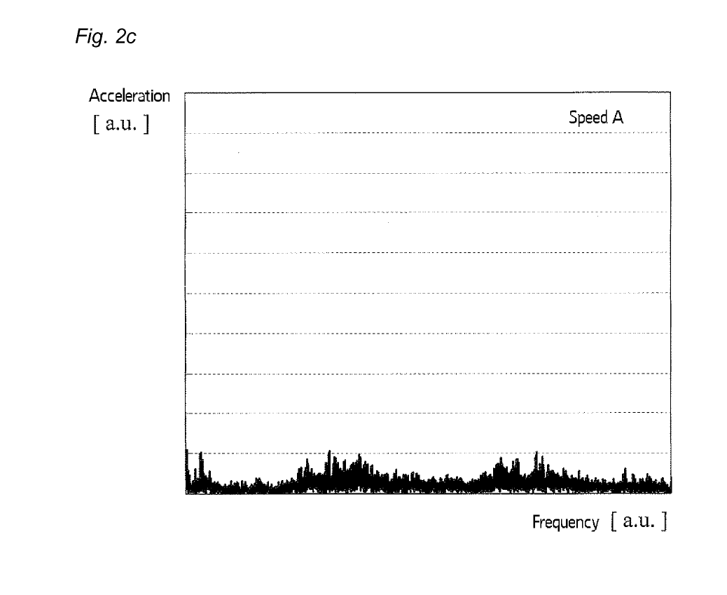

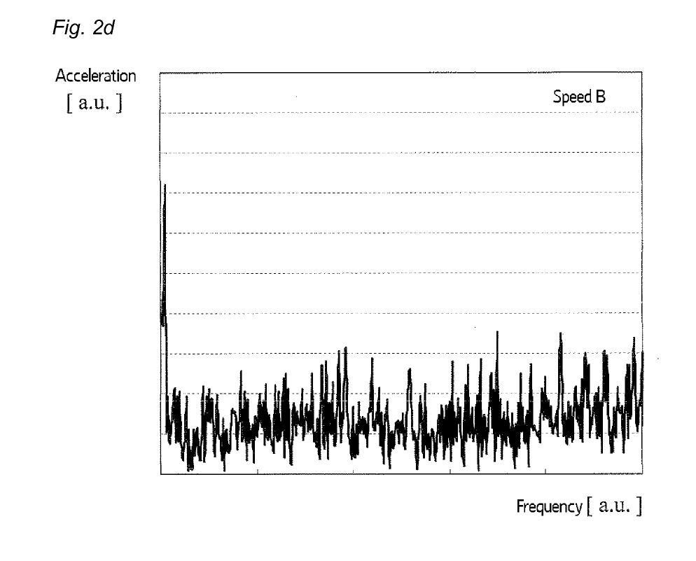

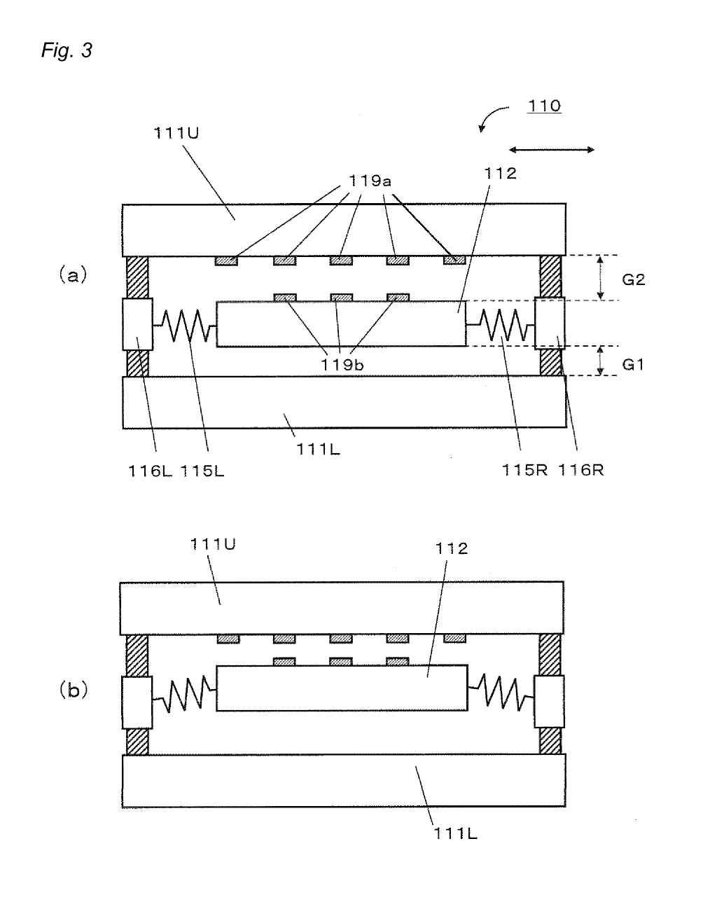

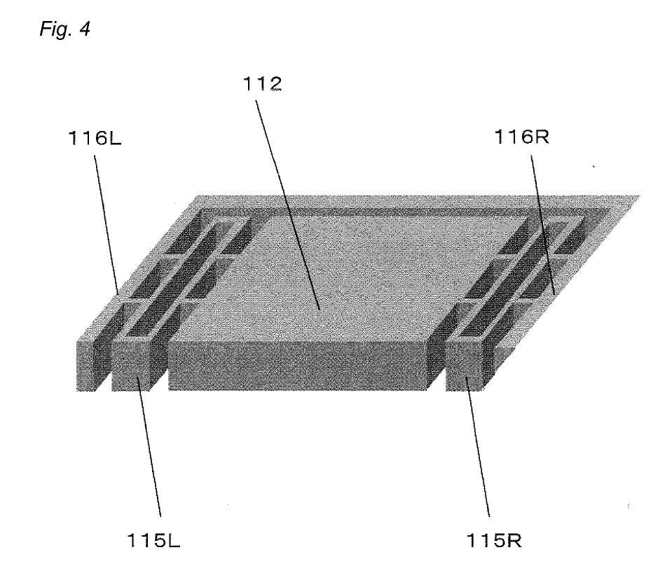

FIG. 1 is view showing a rotating body 100 according to a first embodiment of the present invention. FIGS. 2a to 2d are frequency spectrum of acceleration during the rotation of a tire in a passenger car, which is an example of a rotating body. FIGS. 2a and 2b are spectrums of tangential-direction vibrations during the rotation of the tire at a low speed and a high speed, respectively. FIGS. 2c and 2d are spectrums of axial-direction vibrations during the rotation of the tire at the low speed and the high speed. FIG. 3 is a cross-sectional view showing a structure of the vibration power generator 110 of FIG. 1 and FIG. 4 is a perspective view showing a spring of the vibration power generator 110. It should be noted that, for easy understanding, a wiring structure is omitted in FIGS. 1, 3 and 4.

The rotating body 100 according to the first embodiment has a structure wherein a vibration power generation apparatus 102 is installed in the rotating body 100. The vibration power generation apparatus 102 has a vibration power generator 110 and a circuit 103. In the first embodiment, the rotating body 101 is a member which rotates around a rotational axis (for example, a tire of a car), and can be called “a rotating main body” or “a rotating member.”

When the rotating body is rotated in a rotational direction (a direction of an arrow in the drawing), the vibration power generation apparatus 102 is rotated together with the rotating body 101. At this time, the vibration in the axial direction (a direction perpendicular to a paper surface in FIG. 1(a)) is given as external vibration to the vibration power generator 110 and the vibration power generator 110 converts this into electrical energy to generate power. The power generated is rectified by the circuit 103 and then used for operation of a load (for example, data transmission and lighting operation of LED).

The axial-direction vibration of the rotating body will be described with reference to FIGS. 2a to 2d.

FIGS. 2a and 2b show the frequency spectrums of acceleration of tangential-direction vibration of a tire of a passenger car as the rotating body and FIGS. 2c and 2d show the frequency spectrums of acceleration of axial-direction vibration of the tire. FIGS. 2a to 2d show the spectrums of the tire with respect to the tangential-direction vibration and the axial-direction vibration, respectively, when the car was driven in two driving patterns at speeds A and B by rotating the tires such that the respective speeds are achieved. The speed A is lower than the speed B.

In FIGS. 2a to 2d, the acceleration is shown on the same scale. For this reason, a peak is not observed in FIG. 2b, but the peak of the spectrum appears at the frequency which is indicated by an arrow in FIG. 2b. From these drawings, it is recognized that, as the speed of the car is increased, the peak of the vibration is shifted toward the higher frequency in the spectrum of the tangential-direction vibration of the tire. This is because the rotational speed of the tire is higher. Further, this frequency corresponds to the rotational speed of the tire. It should be noted that, in FIGS. 2a to 2d, the horizontal axis corresponds to frequencies of zero to a few hundreds Hz, and the frequency shown by the arrow in FIG. 2b is three times the frequency at which the peak appears in FIG. 2a.

On the other hand, the vibration greatness (the acceleration) is changed when the speed of the tire is changed in the frequency spectrum of the axial-direction vibration, but the significant peak as observed in the frequency spectrum of the tangential-direction vibration does not appear during the low-speed driving or the high-speed driving. Further, the greatness of the axial-direction vibration is smaller than that of the tangential-direction vibration.

In other words, the rotating body 100 according to this embodiment wherein the vibration in the axial direction of the rotating body 100 is used gives the following effects:

(1) Stable Output; and

(2) A wide range of the frequencies which is utilized is wide.

Detailed description will be made for (1).

Here, the description is made compared to the case where the tangential-direction vibration is used. The frequency at which the peak of the acceleration is observed depends on the speed of the car (the rotational speed of the tire) in the vibration power generator utilizing the tangential-direction vibration. Further, the accelerations at frequencies other than that at which peak appears are very small, such as tenth part of the peaked value. Further, in the vibration power generator utilizing resonance, the power generation amount is very small when the external vibration other than the resonance point is applied. For this reason, although the power generation amount is made large in the vibration power generator utilizing the tangential-direction vibration when the resonance point coincides with the peak of the frequency spectrum at a certain speed, the power generation amount may significantly decrease at other speeds due to the decrease in acceleration of the vibration. In other words, the power generation amount significantly increases or decreases depending on the rotational speed of the tire, in the vibration power generator utilizing the tangential-direction vibration.

On the other hand, the rotating body shown in this embodiment has the vibration power generator which generates power using the axial-direction vibration which shows small change in vibration relative to the change in rotational speed, as described above. In this case, the vibration level is increased by the rotational speed, but the peak value is not significantly shifted and the peak value of acceleration and the accelerations at other frequencies are almost the same.

Accordingly, the rotating body can be provided which gives output stably irrespective of the rotational speed of the rotating body.

Detailed description will be made for (2).

As described in the description for (1), in the tangential-direction vibration, the frequency at which the acceleration reaches the peak is changed when the rotational speed of the rotating body is increased. Further, the output is drastically decreased at the frequencies other than the frequency at which the peak of acceleration appears, when the vibration power generator is designed such that resonance is achieved at the frequency at which the peak of acceleration appears. When the rotational speed of the rotating body is changed and the acceleration reaches the peak in the vibration power generator that is designed such that the tangential-direction vibration is utilized and the resonance is achieved at the frequency at which the acceleration is smallest, it is considered that the vibration (acceleration) applied seems to be ten times the designed value. The vibration power generator should be made large for relaxing elastic strain against a large-amplitude operation of a vibrator in the vibration power generator so as to endure an acceleration that is ten times the designed value, resulting in great disadvantage. Further, the range of frequency to which the vibration power generator using mechanical resonance is adaptive is a range of from a frequency which is 10% smaller than the resonant frequency to a frequency which is 10% larger than the resonant frequency (0.9*resonant frequency to 1.1*resonant frequency). Broadening of the adaptive frequency range and the power generation amount are in trade-off relation and the three-time frequency change is not acceptable to the generator. These mean that the vibration power generator utilizing the tangential-direction vibration of the rotating body should be used in a region where the change in acceleration is small, considering the fact that the peak is shifted when the rotational speed of the rotating body is changed.

On the other hand, the difference in acceleration between the frequency at which the peak (or maximal) acceleration is observed and the other frequencies, is small in the vibration power generator of this embodiment generating power by the axial-direction vibration of the rotating body irrespective the speed of the rotating body and the difference is at most 3 times. Therefore, since the acceleration at a frequency is not ten times as large as the acceleration at another frequency, there is no need of designing the vibration power generator to be larger as described above. Accordingly, the vibration power generator utilizing the axial-direction vibration of the rotating body can be designed such that the available frequency range is larger than the frequency range available to the power generator utilizing the tangential-direction vibration.

The above effects (1) and (2) are achieved as long as the vibration power generator is disposed such that it generates power with the axial-direction vibration of the rotating body, and they are achieved when the vibration power generation apparatus is not any one of the following embodiments.

### (Vibration Power Generator)

Next, the vibration power generator is described.

FIGS. 3(a) and 3(b) are A-A′ cross-sectional views of the vibration power generator 110 which is mounted on the vibration power generation apparatus 102 shown in FIG. 1, and FIG. 3(b) shows a state wherein a movable substrate is displaced in a direction away from the rotational axis of the rotating body by application of the centrifugal force. The vibration power generator 110 includes a fixed substrate 111L as a first fixed substrate, a fixed substrate 111U as a second fixed substrate, and a movable substrate 112 disposed between the fixed substrates 111L and 111U. All the fixed substrates 111L, 111U and the movable substrate 112 are disposed perpendicularly to the radial direction of the rotating body and therefore their surfaces (principal surfaces) are vertical to the radial direction of the rotating body. Fixing structures 116L and 116R are supported on the fixed substrate 111L via connection portions and the fixed substrate 111U is supported thereon via connection portions. In other words, two fixed substrates 111L and 111U are connected via the fixing structures 116L and 116R. Further, the movable substrate 112 is maintained in the air by springs 115L and 115R which are connected to the fixing structures 116L and 116R. All the surfaces (principal surfaces) of the fixed substrates 111L and 111U and the movable substrate 112 have approximately square shape, and parallel to each other.

The fixed substrate 111L is disposed nearer to the rotational axis (that is, the rotational center) side of the rotating body compared to the fixed substrate 111U. A plurality of first electrodes 119a are formed over one surface of the fixed substrate 111U (a lower principal surface of the fixed substrate 111U in FIG. 3) and a plurality of second electrodes 119b are formed at the positions opposed to the respective first electrodes 119a, over a surface of the movable substrate 112 (the upper principal surface in FIG. 3) which surface is opposed to the fixed substrate 111U. Here, one of the first electrode 119a and the second electrode 119b is an electret electrode including a film which holds a charge, and the other is a collector electrode. Both of the first electrode 119a and the second electrode 119b have rectangular shape when viewed in a direction perpendicular to the surfaces of the fixed substrates 111L and 111U, and have approximately the same size. Further, a plurality of the first electrodes 119a and a plurality of the second electrodes 119b are lined up in a direction parallel to the vibrational direction (a direction shown by a double-headed arrow in the drawing) of the movable substrate 112.

A distance between the fixed substrate 111U and the movable substrate 112 (a gap, more strictly a distance between a surface of the first electrode 119a and a surface of the second electrode 119b) is designed such that the movable substrate 112 is maintained in the air even when the movable substrate 112 is displaced toward the fixed substrate 111U side (in a direction away from the rotational center of the rotating body) as shown in FIG. 3(b) by the centrifugal force which is applied to the substrate 112 during the rotation of the rotating body. The contact of the fixed substrate 111U with the movable substrate 112 due to the centrifugal force can be avoided by this gap formation.

Further, as shown in FIG. 3, a gap G1 formed by the fixed substrate 111L and the movable substrate 112 may be smaller than a gap G2 formed by the fixed substrate 111U and the movable substrate 112. This makes it possible to reduce the thickness of the vibration power generator 110.

Next, the operation of the vibration power generator 110 will be described.

As described above, the movable substrate 112 is displaced by external action (vibration) in the vibration power generator structure of this embodiment. After, repulsion force of the springs 115L and 115R applies force to the movable substrate 112 in a direction in which the movable substrate 112 is returned to a desired position, and the substrate 112 is shifted toward the direction to be returned to a predetermined position. The repetition of such displacement vibrates the movable substrate 112 relative to the fixed substrates 111L and 111U in a uniaxial direction. The movable substrate 112 continues to vibrate as long as the application of the external action continues. When the external action is stopped, the vibration is damped and the movable substrate 112 stops.

Displacement of the movable substrate 112 changes the overlapped area between the first electrode 119a and the second electrode 119b, causing a change in a charge amount induced on one of the electrode (the electrode which is not the electret electrode, that is, the collector electrode). The vibration power generation apparatus 110 generates power by outputting this change in charge amount as AC power.

FIG. 4 shows an example of spring structure which enables the movable substrate to be held in the air and can reduce an amount of displacement of the movable substrate in the radial direction of the rotating body when the centrifugal force is applied to the movable substrate. This structure is formed such that a size of the spring in a direction in which the centrifugal force is applied (upward direction in FIG. 4 corresponding to a thickness direction of the movable substrate 112) (thickness) is larger than a size of the spring in the vibrational direction of the movable substrate 112 (a width), and has a large aspect ratio (a dimension in the centrifugal direction/a dimension in the vibrational direction). Such formation of the spring suppresses the displacement of the movable substrate 112 in the direction in which the centrifugal force is applied, and forces the movable substrate 112 to vibrates in the rotational-axis direction of the rotating body, whereby power can be generated.

When the vibration power generator 110, which is described with reference to FIGS. 3 and 4, generates power by the vibration in the axial direction during the rotation of the rotating body, the generator 110 gives the following effects:

(3) Reduction in effect of the centrifugal force; and

(4) Operability under the centrifugal force.

Detailed description will be made for (3). As described above, the movable substrate 112 is held in the air by the springs 115R and 115L in the vibration power generator 110 shown in this embodiment. For this reason, there is no sliding part, whereby the problem of change in sliding resistance due to the centrifugal force is eliminated and the power can be output stably.

Detailed description will be made for (4). In the vibration power generator 110, the springs 115R and 115L are formed into the construction wherein an aspect ratio of the dimension in the centrifugal direction to the dimension in the vibrational direction is large (specifically, more than 1). Therefore, the movable substrate 112 can be vibrated even by a smaller acceleration when the vibration in the rotational axial-direction of the rotating body is exerted, while the displacement of the movable substrate 112 can be made small even if a large acceleration is applied in the centrifugal direction. This makes it possible to vibrate the movable substrate 112 in a predetermined direction under the application of the centrifugal force. As a result, the vibration power generator 110 can be stably operated by the vibration during the rotation of the rotating body irrespective of the rotational speed of the rotating body. Thus, the vibration power generator 110 is useful as a power generator which is disposed fixedly in the rotating body.

Here, members or elements which have not been described above are described. As an electret material for constituting the electret electrode, a polymer material such as polypropylene, polyester terephthalate or polyvinyl chloride or an inorganic material such as silicon oxide can be used. For example, silicon oxide may be particularly used which is excellent in dielectric voltage and heat resistance.

In order to improve the humidity resistance, a structure may be employed wherein an insulating film such as a silicon nitride film covers completely the surroundings of silicon oxide which is a charge-holding film. For example, in use of silicon oxide, the structure wherein the insulating film such as a silicon nitride film completely covers the surroundings of silicon oxide can provide the electret electrode which is excellent in dielectric voltage, heat resistance and humidity resistance.

The rotating body of this embodiment is constructed by installing the vibration power generation apparatus in the rotating body. For this reason, when the vibration power generation apparatus is attached to an outer periphery of the rotating body, the vibration power generation apparatus may be a member protruded from the outer periphery. Since the member protruded from the outer periphery may impede smooth rotation of the rotating body, the vibration power generation apparatus may be installed such that the protruded amount is optimally small. This is the case with the case where the vibration power generation apparatus is attached to another portion of the rotating body. Since the vibration power generation apparatus installed in the rotating body of this embodiment is made thin, it has advantage of reducing the protruded amount.

In this embodiment, an example is shown wherein the vibration power generator 100 has a dimension which is not over a width of the rotating body 101. In a modified example or another embodiment, the vibration power generation apparatus 102 has a dimension which is over the width of the rotating body 101 if high power output is required to be obtained from the vibration power generation apparatus 102.

Further, the first electrodes 119a are formed to cover a region which exceeds the second electrodes 119b (that is, outside the second electrodes 119b), in the vibrational direction of the movable substrate 112 in the vibration power generator 110 of this embodiment. In other words, some first electrodes 119a which do not overlap with the second electrodes always exist when all the second electrodes 119b overlap with the first electrodes 119a as viewed in the direction perpendicular to the surface (principal surface) of the fixed substrate 111U. This is for the purpose of allowing as many second electrodes 119 as possible to contribute to power generation to supply more power.

The first electrodes 119a may be formed up to the position of the limit of vibration (within a range of vibration displacement) of the movable substrate 112 (particularly the first electrode 119a). This makes it possible that all the second electrodes 119b can contribute to the power generation during the vibration of the movable substrate 112. Further, this does not change the number of the first electrodes 119a and the second electrodes 119b that are overlapped with each other during the vibration of the movable substrate 112, whereby the power generation is more stabilized.

In addition, the shape of the surface (principal surface) of the movable substrate 112 is not limited to square, and may be rectangular or other shapes.

### 2. Second Embodiment

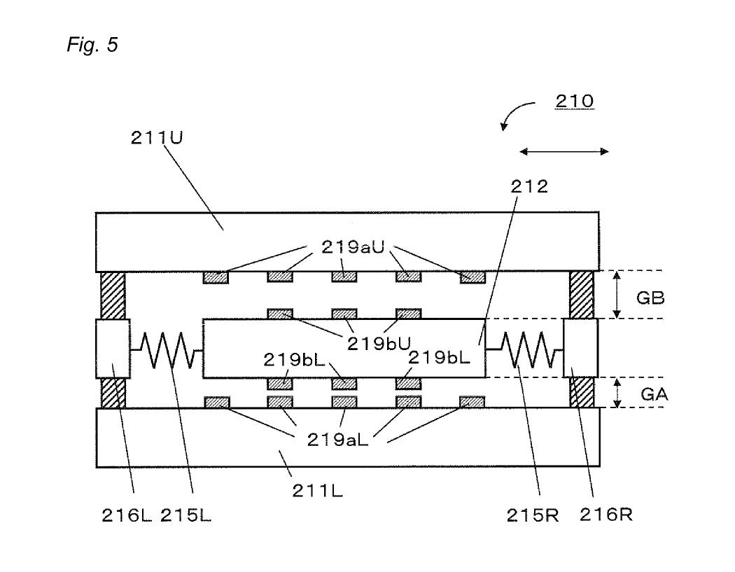

Another vibration power generator which can be installed in the rotating body will be described as the second embodiment. FIG. 5 is a cross-sectional view showing a structure of the vibration power generator 210 of the second embodiment. It should be noted that, for easy understanding, a wiring structure is omitted in FIG. 5.

FIG. 5 is a cross-sectional view showing another embodiment of the vibration power generator installed in the vibration power generation apparatus shown in FIG. 1. FIG. 5 is also a cross-sectional view taken along A-A′ in FIG. 1 and shows a cross section which is parallel to the vibrational direction and the thickness direction of a movable substrate. The vibrational power generator 210 shown in FIG. 5 includes a fixed substrate 211L as a first fixed substrate, a fixed substrate 211U as a second fixed substrate and a movable substrate 212, similarly to that shown in FIG. 3. All the fixed substrates 211L and 211U and the movable substrate 212 are disposed perpendicularly to the radial direction of the rotating body, and therefore their surfaces (principal surfaces) are all perpendicular to the radial direction of the rotating body. Fixing structures 216L and 216R are supported on the fixed substrate 211L via connection portions and the fixed substrate 211U is supported thereon via connection portions. In other words, two fixed substrates 211L and 211U are connected via the fixing structures 216L and 216R. Further, the movable substrate 212 is maintained in the air by springs 215L and 215R connected to the fixing structures 216L and 216R. All the surfaces (principal surfaces) of the fixed substrates 211L and 211U and the movable substrate 212 are square and parallel to each other.

The fixed substrate 211L is disposed nearer to the rotational axis side of the rotating body (that is, the rotational center side of the rotating body) compared to the fixed substrate 211U. A plurality of first electrodes 219aU are formed over one surface of the fixed substrate 211U (the lower principal surface of the fixed substrate 211U in FIG. 5) and a plurality of second electrodes 219bU are formed at the positions opposed to the respective first electrodes 219aU, over a surface of the movable substrate 212 (the upper principal surface in FIG. 5) which surface is opposed to the fixed substrate 211U. Here, one of the first electrode 219aU and the second electrode 219bU is an electret electrode including a film which holds a charge, and the other is a collector electrode.

A plurality of third electrodes 219aL are formed over one surface of the fixed substrate 211L (the upper principal surface of the fixed substrate 211L in FIG. 5) and a plurality of fourth electrodes 219bL are formed at the positions opposed to the respective third electrodes 219aL, over a surface of the movable substrate 212 (the lower principal surface in FIG. 5) which surface is opposed to the fixed substrate 211L. Here, one of the third electrode 219aL and the fourth electrode 219bL is an electret electrode including a film which holds a charge, and the other is a collector electrode.

All the first electrode 219aU, the second electrode 219bU, the third electrode 219aL and the fourth electrode 219bL have rectangular shape when viewed in the direction perpendicular to the surfaces of the fixed substrates 211L and 211U and have approximately the same size. Further, a plurality of first electrodes 219aU, a plurality of second electrodes 219bU, a plurality of third electrodes 219aL and a plurality of fourth electrodes 219bL are lined up in a direction parallel to the vibrational direction (a direction shown by a double-headed arrow in the drawing) of the movable substrate 212.

A distance between the fixed substrate 211U and the movable substrate 212 is designed such that the movable substrate 112 is maintained in the air even when the movable substrate 212 is displaced toward the fixed substrate 211U side by the centrifugal force which is applied to the substrate 212 during the rotation of the rotating body. The contact of the fixed substrate 211U with the movable substrate 212 due to the centrifugal force can be avoided by this gap formation.

Further, as shown in FIG. 5, a gap GA formed by the fixed substrate 211L and the movable substrate 212 is smaller than a gap GB formed by the fixed substrate 211U and the movable substrate 212. As described in the first embodiment, this gap formation makes it possible to carry out the power generation effectively by a pair of the electret electrode and the collector electrode formed over the upper side of the movable substrate 212 as described below, and gives the following effects.

Next, the operation of the vibration power generator 210 is described.

The mechanism of the power generation in this vibration power generator 210 is the same as that of the vibration power generator 110 described in the first embodiment. The power generation is, however, conducted on the upper and lower sides of the movable substrate 212, that is, between the first electrode 219aU and the second electrode 219bU, and between the third electrode 219aL and the fourth electrode 219bL.

Specifically, the power generation is conducted mainly between the third electrode 219aL and the fourth electrode 219bL which form a small gap when the rotational speed of the rotating body is slow and the centrifugal force is small (power generation A). As the centrifugal force is increased and the gap between the fixed substrate 211U and the movable substrate 212 is narrowed, the power generation is conducted mainly between the first electrode 219aU and the second electrode 219bU (power generation B). Therefore, when the vibration power generator 210 of this embodiment generates power by the vibration in the axial direction during the rotation of the rotating body, the generator 210 gives the following effects:

(5) Further stabilization of power generation amount

Detailed description will be made for (5). In the vibration power generator 210 shown in this embodiment, the gap between the fixed substrate 211L and the movable substrate 212 (gap GA) and the gap between the fixed substrate 211U and the movable substrate 212 (gap GB) are configured such that the gap GA<the gap GB, as described above. As a result, the power generation A is larger than the power generation B in the region wherein the rotational speed is slow. As the rotational speed is increased, the gap GA is increased to reduce the power generation A, and the power generation B is increased with the increase in the gap GB. When the rotational speed is further increased, the state wherein the power generation B is larger than the power generation A is achieved. Therefore, even if the rotational speed of the rotating body is changed, the change in power generation amount can be reduced by using the power generation A at the low-speed rotation and using the power generation B at the high-speed rotation, whereby the change in power output due to the centrifugal force can be suppressed to further stabilize the output.

The first electrodes 219aU are formed in such a region that exceeds the second electrodes 219bU (that is, the first electrodes 219aU are formed outside the second electrodes 219bU), in the vibrational direction of the movable substrate 212, similarly to the first embodiment. The first electrode 219aU may be formed up to the position of the limit of vibration (within a range of vibration displacement) of the movable substrate 212 (particularly the second electrode). The same goes for the relation between the third electrodes 219aL and the fourth electrodes 219bL.

The shape of the surface (principal surface) of the movable substrate 212 is not limited to square, and may be rectangular or other shapes.

The members or elements which are not described above are the same as those of the first embodiment. For example, the springs 2125L and 215R have structure of high aspect ratio as shown in FIG. 4. However, the springs 215L and 215R may be another spring. Even when another spring is employed, the effect of the vibration power generator shown in FIG. 5 can be obtained.

### 3. Third Embodiment

Another vibration power generator which can be installed in the rotating body is described as a third embodiment. FIG. 6 includes a cross-sectional view showing a structure of the vibration power generator 310 of the third embodiment (FIG. 6(a)) and a cross-sectional view showing the state wherein a part of the movable substrate 312 is inclined to be displaced toward the rotational axis of the rotating body (FIG. 6(b)). It should be noted that, for easy understanding, a wiring structure is omitted in FIG. 6.

FIG. 6 is a cross-sectional view showing another embodiment of the vibration power generator installed in the vibration power generation apparatus shown in FIG. 1. FIG. 6 is a cross-sectional view taken along A-A′ in FIG. 1 and shows a cross section which is parallel to the vibrational direction and the thickness direction of the movable substrate 312. The vibrational power generator 310 shown in FIG. 6 has approximately the same construction as that of the vibration power generator 210 shown in FIG. 5. That is, the vibration power generator 310 has a fixed substrate 311L as the first substrate, a fixed substrate 311U as the second substrate, fixing structures 316L and 316R connecting these fixed substrates, a movable substrate 312, and springs 315L and 315R for maintaining the movable substrate 312 in the air which are connected to the fixing structures 316L and 316R.

Further, also in the vibration power generator 310, first electrodes 319aU are formed over one surface of the fixed substrate 311U (the lower principal surface of the fixed substrate 311U In FIG. 6), second electrodes 319bU are formed at the positions opposed to the respective first electrodes 319aU, over a surface of the movable substrate 312 (the upper principal surface in FIG. 6) which surface is opposed to the fixed substrate 311U, similarly to the vibration power generator 210 in FIG. 5. Further, third electrodes 319aL are formed over one surface of the fixed substrate 311L (the upper principal surface of the fixed substrate 311L in FIG. 6) and fourth electrodes 319bL are formed at the positions opposed to the respective third electrodes 319aL over a surface of the movable substrate 312 (the lower principal surface in FIG. 6) which surface is opposed to the fixed substrate 311L. Here, one of the first electrode 319aU and the second electrode 319bU and one of the third electrode 319aL and the fourth electrode 319bL are electret electrodes, and the others are collector electrodes.

The vibration power generator 310 is different from the vibration power generator 210 of FIG. 5 in that protruded bodies 313 are formed on the upper principal surface of the fixed substrate 311L. The protruded body 313 is formed by forming an insulating film such as a silicon oxide film or a silicon nitride film followed by patterning. Alternatively, the protruded body 313 is formed by scraping the fixed substrate with etching or the like.

Other constructions and the operation are the same as those of the vibration power generator 210.

When the vibration power generator 310 of this embodiment generates power by the vibration during the rotation of the rotating body, the generator gives the following effects:

(6) Avoidance of stiction.

Detailed description will be made for (6). The protruded body 313 is formed on the upper surface of the fixed substrate 311L in the vibration power generator 310 of this embodiment, as described above. When the movable substrate 312 is displaced with deformation, or when a part of the springs 315L and 315R is deformed or displaced and thereby the surface of the movable substrate 312 is not maintained to be parallel to the surfaces of the fixed substrates 311L and 311U (see FIG. 6(b)), the peripheral portion of the movable substrate 312 (the portion having high acceleration during the vibration) may be deformed or displaced toward the fixed substrate 311L. Even in this case, the amount of deformation or displacement can be minimized by the protruded body. As a result, even if vibration that is not applied during the normal rotation of the rotating body (for example, the vibration which is applied when the tire steps on a stone) is applied to the vibration power generator 310, the stiction between the third electrodes 319aL and the fourth electrodes 319bL can be avoided.

In this embodiment, the gap between the fixed substrate 311L and the movable substrate 312 is smaller than the gap between the fixed substrate 311U and the movable substrate 312. The stiction tends to occur when the gap between the fixed substrate and the movable substrate is small, the protruded body 313 is formed on the surface of the fixed substrate 311L. Alternatively, the protruded body may be formed on the surface of the movable substrate 312.

Alternatively, the protruded body may be formed on the surface of the fixed substrate 311U which surface is opposed to the movable substrate 312. Alternatively, the protruded body may be formed on the surface of the movable substrate 312 near to the fixed substrate 311U side (the principal surface near to the fixed substrate 311U side). The stiction tends to occur when the gap is small, and therefore the protruded body is advantageously formed on the side where the gap is small (between the fixed substrate 311L and the movable substrate 312).

The first electrodes 319aU are formed in such a range that exceeds the area of the second electrodes 319bU (the first electrodes 319aU are formed outside the second electrodes 319bU) in the vibrational direction of the movable substrate 312, similarly to the first embodiment. The first electrodes 319aU may be formed up to the position of the limit of vibration (within a range of vibration displacement) of the movable substrate 312 (particularly the second electrodes 3199bU). The same goes for the relation between the third electrodes 319aL and the fourth electrodes 319bL is the same.

Further, the shape of the surface (the principal surface) is not limited to square and may be rectangular or other shapes.

### 4. Fourth Embodiment

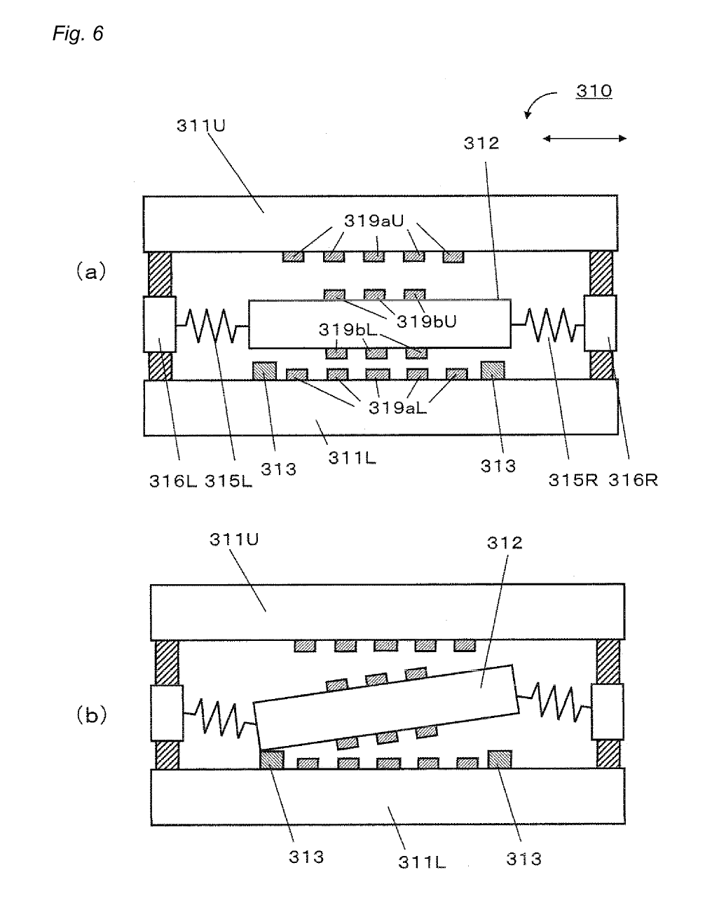

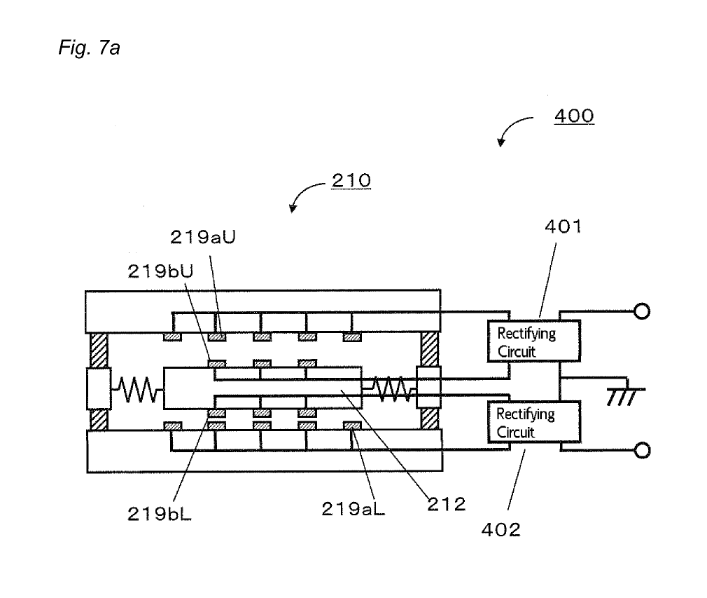

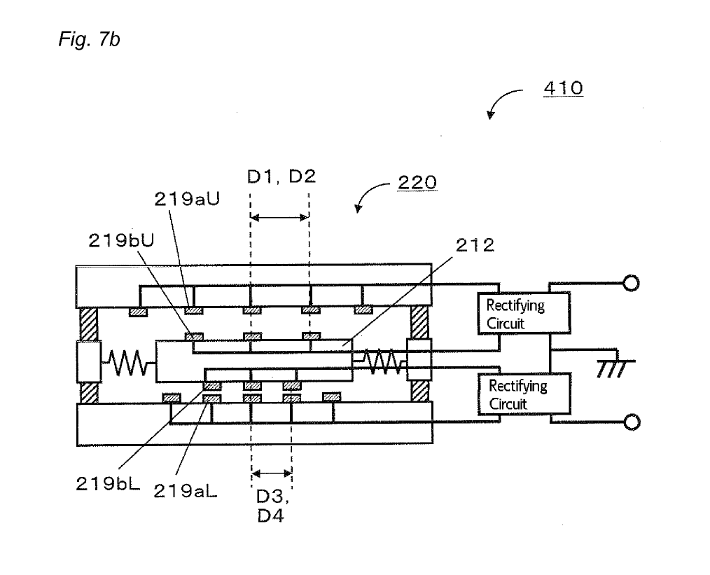

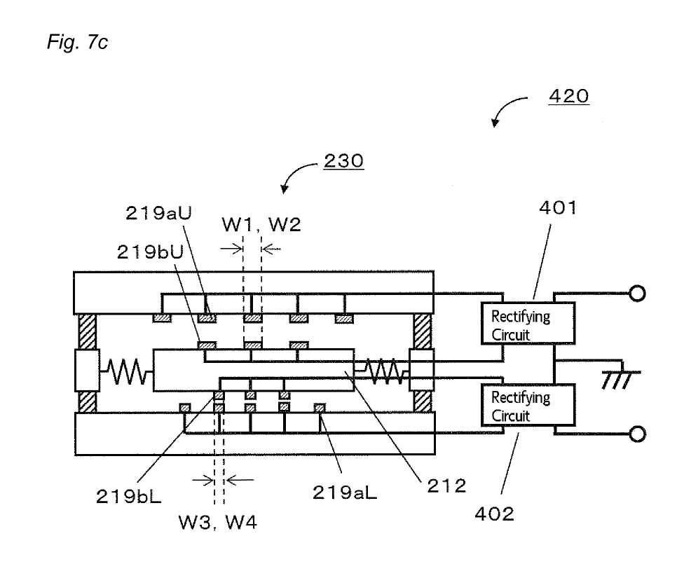

A vibration power generation apparatus which can be installed in the rotating body will be described as a fourth embodiment. FIG. 7a is a view showing a vibration power generation apparatus 400 according to the fourth embodiment.

In FIG. 7a, the vibration power generator 210 is one illustrated in the second embodiment. In the vibration power generation apparatus 400, a rectifying circuit 401 is connected between the first electrode 219a and the second electrode 219b. Further, another rectifying circuit 402 is connected between the third electrode 219aL and the fourth electrode 219bL.

The operation of the vibration power generation apparatus as constructed in this manner will be described.

When the rotational speed of the rotating body is slow, the amount of power generated by the third electrodes 219aL and the fourth electrodes 219bL is larger than the amount of power generated by the first electrode 219aU and the second electrode 219bU in the vibration power generator 210, and thus the output voltage from the rectifying circuit 402 is larger than the output voltage from the rectifying circuit 401. As a result, the voltage of the rectifying circuit 402 is applied to a load. Further, when the rotational speed of the rotating body is fast, the amount of power generated by the first electrodes 219aU and the second electrodes 219bU is larger than the amount of power generated by the third electrodes 219aL and the fourth electrodes 219bL, and thus the output voltage from the rectifying circuit 401 is larger than the output voltage from the rectifying circuit 402. As a result, the voltage of the rectifying circuit 401 is applied to the load.

When the power generation apparatus 400 of this embodiment generates power by the vibration during the vibration of the rotating body, the generator 400 gives the following effects:

(7) Stable power supply to the load.

Detailed description will be made for (7). As described above, the vibration power generation apparatus 400 of this embodiment is constructed such that the larger output of two outputs which are given during the rotation of the rotating body can be supplied to the load. As a result, a relatively constant power is sent to the load during both low speed rotation and high speed rotation of the rotating body, whereby the change in power transmission to the load can be small.

In this embodiment, a structural example is shown wherein a distance between centers of two adjacent first electrodes 219aU, a distance between centers of two adjacent second electrodes 219bU, a distance between centers of two adjacent third electrodes 219aL, and a distance between two adjacent fourth electrodes 219bL are all the same. In order to reduce the change in frequency of the output voltage due to the difference in rotational speed of the rotating body, a distance D1 between centers of two adjacent first electrodes 219aU, a distance D2 between centers of two adjacent second electrodes 219bU, a distance D3 between centers of two adjacent third electrodes 219aL, and a distance D4 between centers of two adjacent fourth electrodes 219bL may be set such that they satisfy D1=D2>D3=D4, as a modified example in FIG. 7b. This construction can further stabilize the power.

The vibration power generation apparatus 410 shown in FIG. 7b is the same as that shown in FIG. 7a except that the vibration power generator 220 is one illustrated in the drawing. In the vibration power generator 220, a plurality of first electrodes 219aU of rectangular shape are lined up parallel to each other in a direction parallel to the vibrational direction of the movable substrate 212. The same goes for the second electrodes 219bU, the third electrodes 219aL and the fourth electrodes 219bL. As described above, the distances between two adjacent electrodes formed on the respective substrate satisfy D1=D2>D3=D4. This is because the vibration greatness during the low-speed rotation is smaller than the vibration greatness (the acceleration greatness) during the high-speed rotation. As the vibration greatness (the acceleration greatness) is larger, the force exerted on the movable substrate 212 in the vibration power generator 220 is larger, resulting in a larger vibration, that is, faster vibration of the movable substrate 212. As the vibrational speed of the movable substrate 212 is higher, the frequency of voltage output from the vibration power generator 410 is higher and the impedance is lower.

On the other hand, it is advantageous that the frequency of voltage output from the vibrational power generator is not fluctuated to be constant in order to match the impedance between the vibration power generator and the load. Thus, in the vibration power generator 410 shown in FIG. 7b, the distance between two adjacent electrodes in a pair of the electrodes used for the power generation during the high-speed rotation (specifically, a pair of the first electrodes and the second electrodes) is made larger, and the distance between two adjacent electrodes in a pair of the electrodes used for the power generation during the low-speed rotation (specifically, a pair of the third electrodes and the fourth electrodes is made smaller in order that the change in frequency of output is small even if the vibrational seed of the movable substrate 212 is changed. This construction makes it possible to obtain more stable power from the vibration power generator 410 irrespective of the speed of the rotating body.

Alternatively, in the vibration power generator 410 shown in FIG. 7b, a width of the rectangular electrode may be larger in a pair of the electrodes used for power generation during the high-speed rotation, and may be smaller in a pair of the electrodes used for power generation during the low-speed rotation. In other words, the electrodes may be designed so as to satisfy the relation of W1=W2>W3=W4 assuming that the width of the first electrode, the width of the second electrode, the width of the third electrode in the vibrational direction of the movable substrate and the width of the fourth electrode are W1, W2, W3 and W4, respectively. Such a modified example is shown in FIG. 7c.

A vibration power generation apparatus 420 shown in FIG. 7c is the same as that shown in FIG. 7b except that a vibration power generator 230 is one illustrated in the drawing. In the vibration power generator 230, a plurality of first electrodes 219aU of rectangular shape are lined up parallel to each other in a direction parallel to the vibrational direction of the movable substrate 212. The same goes for the second electrodes 219bU, the third electrodes 219aL and the fourth electrodes 219bL. Further, as described above, the width of the first electrode 219aU (W1), the width of the second electrode 219bU (W2), the width of the third electrode 219aL (W3) and the width of the fourth electrode 219bL (W4) satisfy W1=W2>W3=W4 in the electrodes formed over the respective substrates. Although the vibration is small during the low-speed rotation and thus vibration amplitude of the vibrating body 212 is also small, this construction makes it possible to conduct power generation even at a small vibration amplitude because of small electrode widths (W3, W4). Further, the vibrating body 212 is operated at larger amplitude during the high-speed rotation compared to the low-speed rotation since the applied vibration is large, causing faster increase and decrease in overlapped area of the electrodes. The electrode widths (W1, W2) is, however, large because of the electrode construction shown in FIG. 7c and therefore the output voltage in a period has smaller change compared to that during the low-speed rotation. Accordingly, this modified example also makes it possible to obtain stabler power from the vibration power generator irrespective of the speed of the rotating body.

The rotating body described above is provided as, for example, a rotating body for a vehicle. The rotating bodies for vehicle include rotating bodies used in motorcycles, three-wheeled vehicles and cars (including a passenger car, a bus), industrial vehicles (for example, a truck), vehicles for agriculture (for example, a tractor), vehicles for construction (for example, a crane car). The rotating body is, for example, a tire used in any of these vehicles. Alternatively, the rotating body may be a rotating body included a motor such as, a rotating body included in an engine or an electric motor, or a rotating body included in a generator. For example, the power from the rotating body may be used for evaluating the performance of the rotating body itself. Specifically, the power may be used for monitoring air pressure of the tire and transmitting the monitoring results. Alternatively, the power from the rotating body may be used for lighting up a light source (for example, a LED lamp).

### 5. Fifth Embodiment

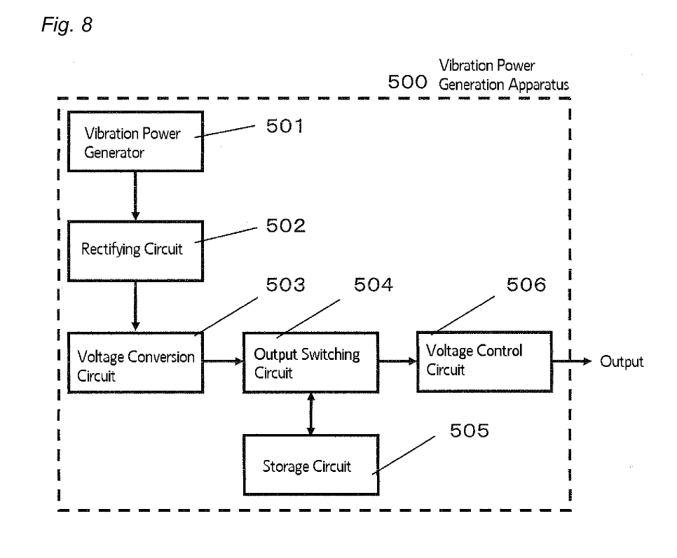

A vibration power generation apparatus which can be installed in the rotating body is described as a fifth embodiment. FIG. 8 is a block diagram of the vibration power generation apparatus of the fifth embodiment. In FIG. 8, a vibration power generator is any one of the vibration power generators shown in the first to fourth embodiments.

Referring to FIG. 8, the vibration power generation apparatus 500 consists of the vibration power generator 501, a rectifying circuit 502, a voltage conversion circuit 503, an output switching circuit 504, a storage circuit 505, and a voltage control circuit 506. An AC voltage output from the vibration power generator 501 is converted into a DC voltage by the rectifying circuit 502. The DC voltage is input to the voltage conversion circuit 503 and converted into a level of an output voltage of the vibration power generation apparatus 500. The converted voltage is input to the voltage control circuit 506 or the storage circuit 505 by the output switching circuit 504. Output is made by the voltage control circuit 506 which controls the output voltage at a certain level.

Now, the operation of the vibration power generation apparatus 500 with the above structure will be described.

An AC voltage is output from the vibration power generator 501. Here, description is made assuming that the output voltage is sinusoidal, but the actual voltage wave form of the output voltage from the vibration power generator 501 depends on the vibration amplitude of the movable substrate, the gap between the movable substrate and the fixed substrate, an amount of charge held by the electret film and an amount of external impedance viewed in the vibration power generator 501. The AC voltage output from the vibration power generator 501 is converted to a DC voltage VDC1 by the rectifying circuit 502. The DC voltage VDC1 is converted to an output voltage level VDC2 of the vibration power generation apparatus 500 by the voltage conversion circuit 503. The switching operation of the operation switching circuit 504 is made in such a manner that; when the output of the voltage from the vibration power generation apparatus 500 is not required, the generated power is stored in the storage circuit 505 without outputting to the voltage control circuit 506; and when the output of the voltage from the vibration power generation apparatus 500 is required and the power generation amount is small, the power stored in the storage circuit 505 is output. The output from the output switching circuit 504 is controlled to a desired output voltage VOUT by the voltage control circuit 506.

As mentioned above, the voltage output from the vibration power generator 500 is changed due to various factors. For adapting to this change, the voltage VDC2 may be set to a slightly higher level than the voltage VOUT finally output. Such setting can make the output voltage constant even in fine fluctuations in voltage. For example, the case of outputting a voltage of 1.8V will be described below. When the VDC2 is set to 1.8V, the decrease in output voltage from the vibration power generator also decreases the output voltage from the vibration power generator 500. For example, when the VDC2 is set to 2V, control can be sufficiently made for the decrease in voltage by 0.2 V of the power generator. This is very advantageous from the viewpoint of practical use.

### 6. Sixth Embodiment

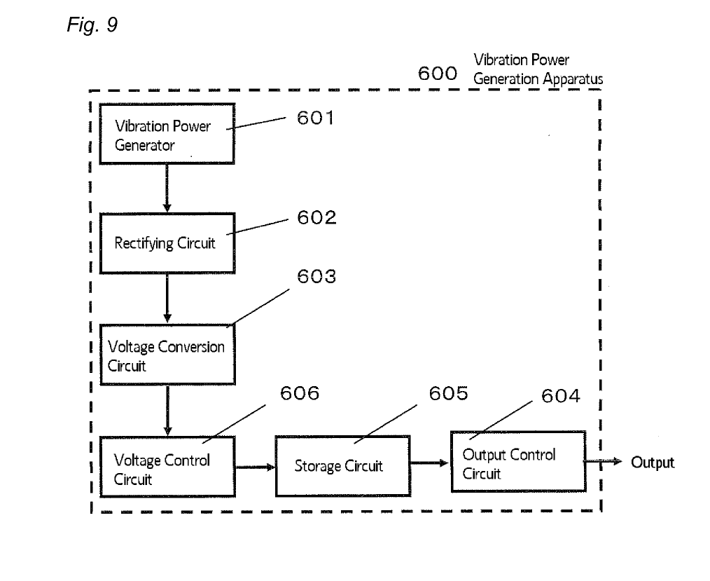

A vibration power generation apparatus which can be installed in the rotating body will be described as a sixth embodiment. FIG. 9 is a block diagram showing a structure of a vibration power generation apparatus of the sixth embodiment. In FIG. 9, a vibration power generator is any one of the vibration power generators shown in the first to the fourth embodiments.

In FIG. 9, the vibration power generation apparatus 600 includes the vibration power generator 601, a rectifying circuit 602, a voltage conversion circuit 603, an output switching circuit 604, a storage circuit 605, and a voltage control circuit 606. An AC voltage output from the vibration power generator 601 is converted into the DC voltage by the rectifying circuit 602. The DC voltage is input to the voltage conversion circuit 603, and converted into a voltage at a controllable voltage level of the vibration power generation apparatus 600. The converted voltage is controlled to a desired voltage by the voltage control circuit 606 and input to the storage circuit 605. The output control circuit 604 controls the electrical power stored in the storage circuit 605 according to the state of a load, and outputs the electric power to the load.

The vibration power generation apparatus 600 with such a structure also gives the same effects as the vibration power generation apparatus 500. The operation of the vibration power generation apparatus 600 is substantially the same as the vibration power generation apparatus 500. The output voltage from the voltage control circuit 606 is controlled to an optimal voltage for the storage circuit 605. The output control circuit 604 controls the output from the vibration power generation apparatus 600 depending on the state of the load.

### 7. Seventh Embodiment

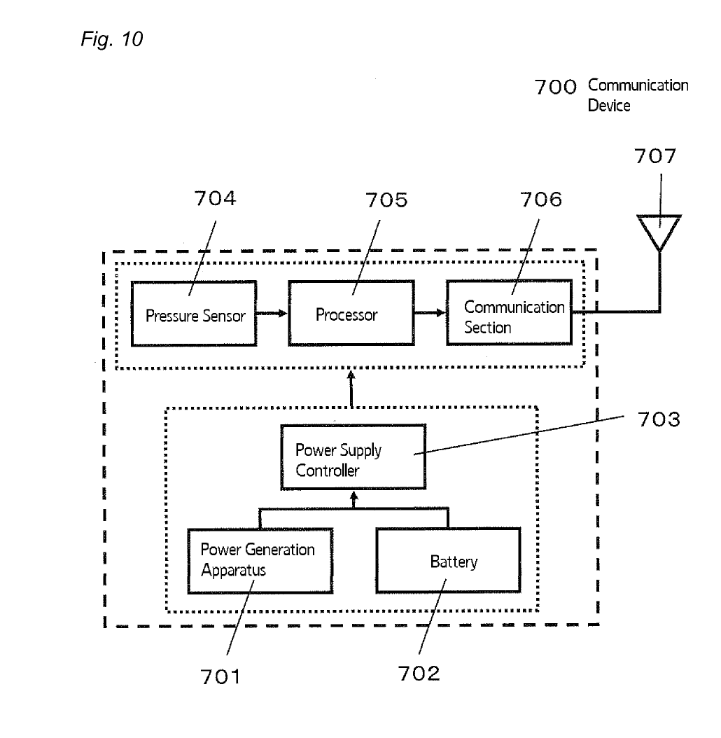

FIG. 10 is a block diagram of a communication device 700 for use in a tire air pressure monitoring system mounted on a vehicle. The communication device 700 is constructed to operate by supply of power generated by the tire in the case where the tire for a vehicle is the rotating body of an embodiment of the present invention. In FIG. 10, a power generation apparatus 701 corresponds to the vibration power generation apparatus shown in the fifth or sixth embodiment.

In FIG. 10, the communication device 700 includes: the power generation apparatus 701 for generating power due to the vibration; a battery 702 serving as a main power supply of the communication device or a sub-power supply of the power generation apparatus 701; a power supply controller 703 for switching between an output from the power generation apparatus 701 and an output from the battery 702 to supply the output to a circuit section; a pressure sensor 704 for measuring the pressure of air of the tire; a processor 705 for processing the output from the pressure sensor to send the output to a communication section; the communication section 706 for converting an input signal from the processor 705 into a high frequency signal to transfer the signal to an antenna 707, and the antenna 707.

The operation of the communication device 700 with the above structure will be described below.

The power necessary for operation of the pressure sensor 704, the processor 705, and the communication section 706, is supplied from the power generation apparatus 701 or battery 702 by the power supply controller 703. The pressure sensor 704 measures the pressure of air of the tire, and converts the result of measurement into a voltage signal, which is input to the processor 705. The signal processed by the processor 705 is input to the communication section 706 and a high-frequency signal is transmitted from the antenna 707.

The use of the vibration power generation apparatus as a power supply for the communication device in this way can reduce the number of maintenance operations, including battery replacement, or can eliminate the battery replacement, which improves the convenience of the communication device itself and contributes to resource saving and environmental protection.

This embodiment has described an example of using both the vibration power generation apparatus and the battery. When the output power from the vibration power generation apparatus can sufficiently cover the power to be consumed in circuits such as the pressure sensor, the processor, and the communication section, as well as the power required for communication, only the vibration power generation apparatus may be used as the power supply. In this case, the battery and the power supply controller are not required, which is advantageous in reduction in the size of the device.

In this embodiment, only the block diagram of the communication device provided with the pressure sensor is shown. It is apparent that the same effect can be achieved in a communication device which is provided with a sensor and a control circuit for controlling power by detecting the operation state of a vehicle.

This embodiment has described the example of using any one of the vibration power generation apparatuses described in the fifth or sixth embodiment. The same effects can be obtained by another vibration power generation apparatus as long as the apparatus is one which converts external vibration caused by the rotation of the rotating body into power.

### 8. Eighth Embodiment

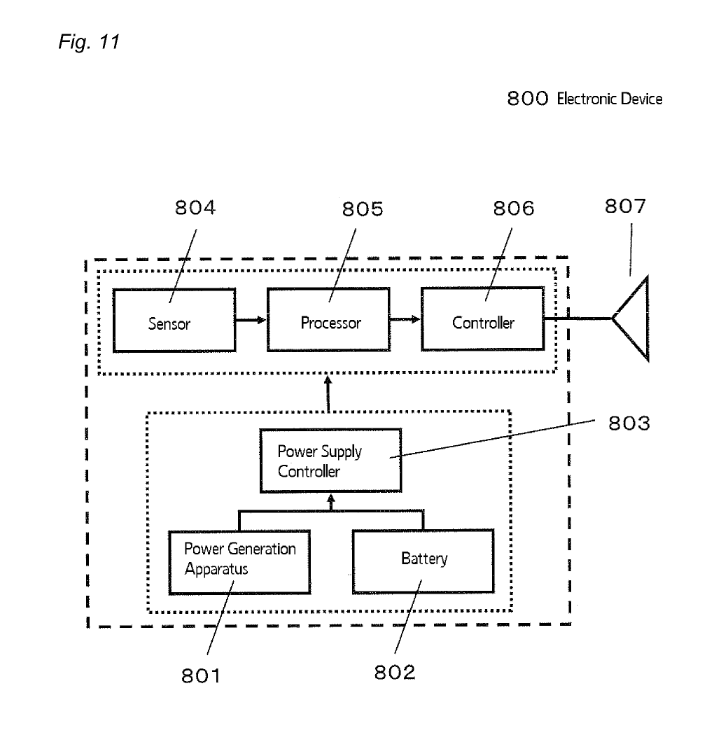

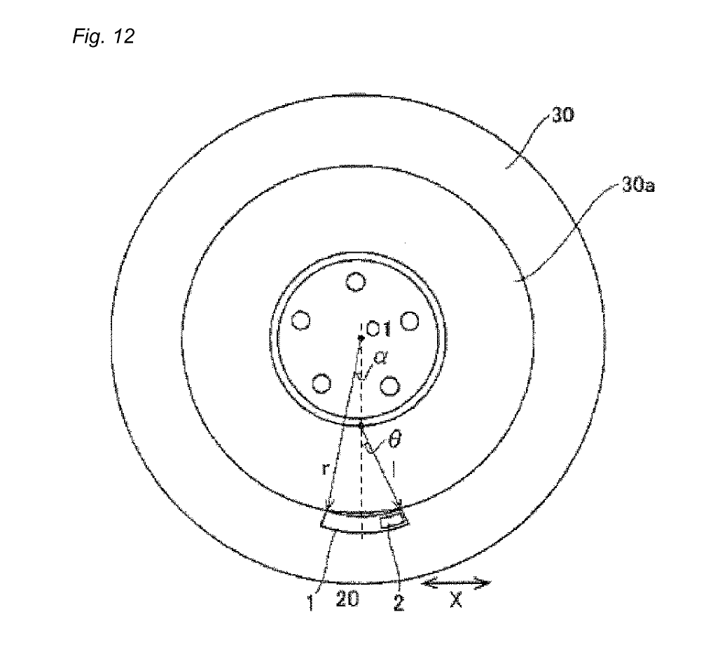

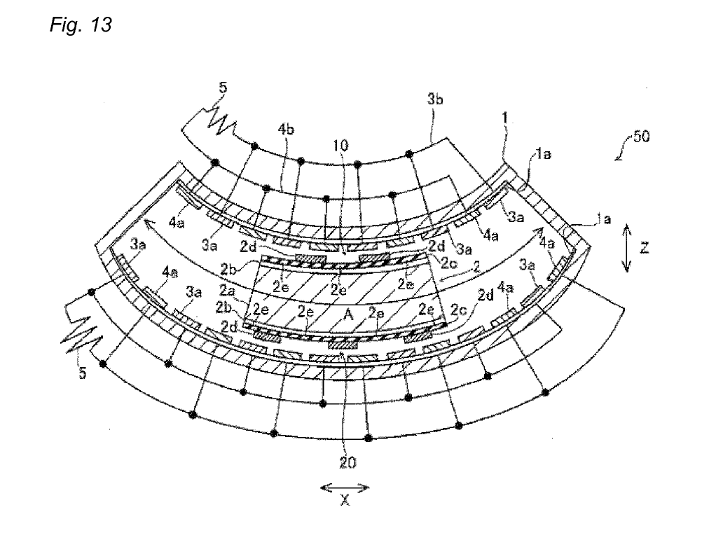

FIG. 11 is a block diagram of an electronic device 800 that makes sound. In FIG. 11, a power generation apparatus 801 is the vibration power generation apparatus according to the fifth or sixth embodiment.

In FIG. 11, the electronic device 800 includes: a power generation apparatus 801 for generating power by vibration; a battery 802 serving as a main power supply for a communication device, or a sub-power supply for the power generation apparatus 801; a power supply controller 803 for switching among an output from the power generation apparatus 801 and an output from the battery 802 to supply the power to a circuit section; a sensor 804 for detecting a response from the outside (for example, a button push, or a tilt of the device, or the like); a processor 805 for processing the output from the sensor to transfer the output to a communication section; the controller 806 for transmitting an input signal from the processor 805 to a speaker 807; and the speaker 807.

The operation of the communication device (electronic device) 800 with the above structure will be described below.

The power necessary for operation of the sensor 804, the processor 805, and the controller 806 is supplied from the power generation apparatus 801 or battery 802 by the power supply controller 803. The sensor 804 detects a response from the outside and inputs the detected result to the processor 805. When a signal processed by the processer 805 exceeds a desired level, the signal is input to the controller 806 to produce sound from the speaker 807.

In this way, the use of the vibration power generation apparatus as a power supply for the electronic device can reduce the number of maintenance operations, including battery replacement, or can eliminate the battery replacement, which improves the convenience of the communication device itself and contributes to resource saving and environmental protection.

This embodiment has described the example of using both the vibration power generation apparatus and the battery. When the output power from the vibration power generation apparatus can sufficiently cover the power to be consumed in circuits such as the pressure sensor, the processor and the controller, as well as the power required for communication, only the vibration power generation apparatus may be used as the power supply. In that case, the battery and the power supply controller are not required, which is advantageous in reduction in the size of the device.

This embodiment has described the example of using any one of the vibration power generation apparatuses described in the fifth or sixth embodiment. It is needless to say that the same effects can be obtained by another vibration power generation apparatus as long as the apparatus is one which can converts external vibration caused by the rotation of the rotating body into power.

The embodiments disclosed herein are in all respects merely embodiments and should in no way be construed as limiting. The scope of the invention is indicated not by the foregoing description but by the scope of the claims for patent, and is intended to include all modifications that are within the scope and meanings equivalent to the scope of the claims for patent.

### INDUSTRIAL APPLICABILITY

The rotating body according to an embodiment of the present invention is useful in that a vibration power generator generates power at a stable output voltage to supply stable power output to an electronic device irrespective of a rotational speed of the rotating body. Further, the rotating body of the embodiment of the present invention can be used integrally with a wireless communication module of low power, and therefore is very useful as a vehicle tire provided with an air-pressure sensor for tire.

### DESCRIPTION OF REFERENCE NUMERALS

100 Rotating body with vibration power generation apparatus
101 Rotating body
102 Vibration power generation apparatus
110, 210, 220, 310 Vibration power generator
111, 211, 311 Fixed substrate
112, 212, 312 Movable substrate
115, 215, 315 Spring
116, 216, 316 Fixing structure
400, 410 Vibration power generation apparatus
500 Vibration power generation apparatus
600 Vibration power generation apparatus
700 Communication device
800 Electronic device

1. A vibration power generator comprising:
a first fixed substrate;
a second fixed substrate which is disposed to be opposed to the first fixed substrate;
a movable substrate which is disposed between the first fixed substrate and the second fixed substrate to be opposed to the first fixed substrate and the second fixed substrate, and is vibratory with respect to the first fixed substrate and the second fixed substrate;
a plurality of first electrodes formed over a surface of the second fixed substrate which surface is opposed to the movable substrate;
a plurality of second electrodes formed over a surface of the movable substrate which surface is opposed to the second fixed substrate;
wherein one of the first electrode and the second electrode comprises a film holding a charge, and
a first gap is smaller than a second gap assuming that the first gap is a distance between the first fixed substrate and the movable substrate and the second gap is a distance between the second fixed substrate and the movable substrate.

2. The vibration power generator according to claim 1 which further comprises:
a plurality of third electrodes formed over a surface of the first fixed substrate which surface is opposed to the movable substrate; and
a plurality of fourth electrodes formed over a surface of the movable substrate which surface is opposed to the first fixed substrate;
wherein one of the third electrode and the fourth electrode comprises a film holding a charge.

3. The vibration power generator according to claim 2, wherein:
a direction in which the first electrodes, the second electrodes, the third electrodes and the fourth electrodes are lined up is parallel to a vibrational direction of the movable substrate;
the first electrodes are disposed such that they are parallel to each other and distances D1 are the same wherein each distance D1 is a distance between centers of two adjacent first electrodes;
the second electrodes are disposed such that they are parallel to each other and distances D2 are the same wherein each distance D2 is a distance between centers of two adjacent second electrodes;
the third electrodes are disposed such that they are parallel to each other and distances D3 are the same wherein each distance D3 is a distance between centers of two adjacent third electrodes;
the fourth electrodes are disposed such that they are parallel to each other and distances D4 are the same wherein each distance D4 is a distance between centers of two adjacent fourth electrodes; and
D1, D2, D3 and D4 satisfy a relation of D1=D2>D3=D4.

4. The vibration power generator according to claim 2, wherein:
the first electrodes, the second electrodes, the third electrodes and the fourth electrodes have a rectangular shape when viewed in a direction perpendicular to the surface of the first substrate;
a direction in which the first electrodes, the second electrodes, the third electrodes and the fourth electrodes are lined up is parallel to a vibrational direction of the movable substrate; and
W1, W2, W3 and W4 satisfy a relation of W1=W2>W3=W4 wherein W1, W2, W3 and W4 are a width of the first electrode, a width of the second electrode, a width of the third electrode, and a width of the fourth electrode in the vibrational direction of the movable direction, respectively.

5. The vibration power generator according to claim 1, which further comprises:
a fixing structure which connects the first fixed substrate and the second fixed substrate; and
a spring connected to the fixing structure and the movable substrate;
wherein the movable substrate is maintained in the air by the spring, and
a size of the spring in a vibrational direction of the movable substrate is smaller than a size of the spring in a thickness direction of the movable substrate.

6. A vibration power generation apparatus comprising:
a vibration power generator according to claim 1; and
a circuit which converts an AC output voltage from the vibration power generator and outputs a DC voltage.

7. The vibration power generation apparatus according to claim 6, which further comprises a battery.

8. A rotating body comprising a vibration power generation apparatus wherein:
the vibration power generation apparatus comprises a vibration power generator and a circuit which converts an AC output voltage from the vibration power generator and outputs a DC voltage;
the vibration power generator comprises:
a first fixed substrate;
a second fixed substrate which is disposed to be opposed to the first fixed substrate;
a movable substrate which is disposed between the first fixed substrate and the second fixed substrate to be opposed to the first fixed substrate and the second fixed substrate, and is vibratory with respect to the first fixed substrate and the second fixed substrate;
a plurality of first electrodes formed over a surface of the second fixed substrate which surface is opposed to the movable substrate;
a plurality of second electrodes formed over a surface of the movable substrate which surface is opposed to the second fixed substrate;
wherein one of the first electrode and the second electrode comprises a film holding a charge, and a first gap is smaller than a second gap assuming that the first gap is a distance between the first fixed substrate and the movable substrate and the second gap is a distance between the second fixed substrate and the movable substrate;
wherein the first fixed substrate, the second fixed substrate and the movable substrate are disposed perpendicular to a radial direction of the rotating body, and
the vibration power generator is fixed to the rotating body such that the first fixed substrate is disposed on the rotational axial side of the rotating body.

9. The rotating body according to claim 8 wherein the vibration power generator further comprises:
a plurality of third electrodes formed over a surface of the first fixed substrate which surface is opposed to the movable substrate; and
a plurality of fourth electrodes formed over a surface of the movable substrate which surface is opposed to the first fixed substrate;
wherein one of the third electrode and the fourth electrode comprises a film holding a charge.

10. The rotating body according to claim 9, wherein, in the vibration power generator,
a direction in which the first electrodes, the second electrodes, the third electrodes and the fourth electrodes are lined up is parallel to a vibrational direction of the movable substrate;
the first electrodes are disposed such that they are parallel to each other and distances D1 are the same wherein each distance D1 is a distance between centers of two adjacent first electrodes;
the second electrodes are disposed such that they are parallel to each other and distances D2 are the same wherein each distance D2 is a distance between centers of two adjacent second electrodes;
the third electrodes are disposed such that they are parallel to each other and distances D3 are the same wherein each distance D3 is a distance between centers of two adjacent third electrodes;
the fourth electrodes are disposed such that they are parallel to each other and distances D4 are the same wherein each distance D4 is a distance between centers of two adjacent fourth electrodes; and
D1, D2, D3 and D4 satisfy a relation of D1=D2>D3=D4.

11. The rotating body according to claim 10, wherein, in the vibration power generator,
the first electrodes, the second electrodes, the third electrodes and the fourth electrodes have a rectangular shape when viewed in a direction perpendicular to the surface of the first substrate;
a direction in which the first electrodes, the second electrodes, the third electrodes and the fourth electrodes are lined up is parallel to a vibrational direction of the movable substrate; and
W1, W2, W3 and W4 satisfy a relation of W1=W2>W3=W4 wherein W1, W2, W3 and W4 are a width of the first electrode, a width of the second electrode, a width of the third electrode, and a width of the fourth electrode in the vibrational direction of the movable direction, respectively.

12. The rotating body according to claim 8, wherein the vibration power generator further comprises:
a fixing structure which connects the first fixed substrate and the second fixed substrate; and
a spring connected to the fixing structure and the movable substrate;
wherein the movable substrate is maintained in the air by the spring, and
a size of the spring in a vibrational direction of the movable substrate is smaller than a size of the spring in a radial direction of the movable substrate.

13. The rotating body according to claim 9, wherein the vibration power generation apparatus comprises at least:
a first rectifying circuit which is connected to the first electrodes and the second electrodes of the vibration power generator; and
a second rectifying circuit which is connected to the third electrodes and the fourth electrodes of the vibration power generator;
wherein a voltage of one of the first rectifying circuit and the second rectifying circuit is supplied to a load.

14. The rotating body according to claim 8, wherein the vibration power generation apparatus comprises:
a voltage conversion circuit for converting a DC voltage output from the rectifying circuit into a voltage at a predetermined voltage level;
a storage circuit for storing power generated by the vibration power generator when an output from the vibration power generation apparatus is unnecessary;
a voltage control circuit for controlling an output voltage from the voltage conversion circuit or the storage circuit to a predetermined voltage; and
an output switching circuit for switching the output from the voltage conversion circuit to the storage circuit or the voltage control circuit.

15. The rotating body for a vehicle, which is the rotating body according to claim 8.

16. A communication device comprising the vibration power generation apparatus according to claim 6.

17. An electronic device which comprises the vibration power generation apparatus according to claim 6.
